(19) United States
(12) Patent Application Publication
(10) Pub. No.: US 2026/0266314 A1
(43) Pub. Date: Sep. 10, 2026

(54) METHOD FOR REMOVING A BLOCKAGE OF A CENTRIFUGAL PUMP

(71) Applicant: WILO SE, Dortmund (DE)

(72) Inventors: Jens Fiedler, Dortmund (DE); Thomas Habermann, Dortmund (DE); Alfred Otto, Dortmund (DE)

(21) Appl. No.: 19/548,489

(22) Filed: Feb. 24, 2026

(30) Foreign Application Priority Data
Mar. 5, 2025 (BE) 2025/5136

(51) Int. Cl. F04D 29/70; F04D 1/00; F04D 15/00

(52) U.S. Cl. CPC F04D 29/708; F04D 1/00; F04D 15/0027; F04D 15/0088

(57) ABSTRACT

A method for removing a blockage of a centrifugal pump, which includes an electric motor for driving the centrifugal pump, includes the steps of: after and/or while carrying out a cleaning sequence to remove the blockage, checking whether a starting energy which is consumed by the electric motor during a start-up phase and is determined by integration of an electrical power consumption of the electric motor exceeds a starting energy threshold value; and if so, carrying out the cleaning sequence again and/or in a continuing manner.

### CROSS-REFERENCE TO RELATED APPLICATIONS

The present application is based upon and claims the right of priority to BE Patent Application No. 2025/5136, filed on Mar. 5, 2025, the disclosure of which is hereby incorporated by reference herein in its entirety for all purposes.

### TECHNICAL FIELD

The invention relates to a method for removing a blockage of a centrifugal pump comprising an electric motor for driving the centrifugal pump, comprising the step of carrying out a cleaning sequence to remove the blockage. The invention further relates to a centrifugal pump comprising an electric motor for driving the centrifugal pump and a closed-loop and/or open-loop control device for carrying out a cleaning sequence to remove a blockage.

### BACKGROUND OF THE INVENTION

Centrifugal pumps are used in various fields of application, in particular in wastewater systems or industrial conveying systems, for conveying liquids. During operation, such centrifugal pumps can become blocked by foreign objects, deposits, or solid matter. In particular in wastewater applications, foreign objects in the form of textiles are often found in the conveying medium. These textiles can accumulate at various points within the centrifugal pump, and can for example wrap around an impeller of the centrifugal pump or get caught in an intake manifold of the centrifugal pump. Such accumulation results in increased power consumption of the centrifugal pump, increased wear, and/or the centrifugal pump becoming blocked and clogged. A blocked centrifugal pump often has to be disassembled and cleaned, or even replaced.

To resolve such a blockage, the centrifugal pump can be operated in a so-called cleaning sequence, in which the impeller is repeatedly operated in a forward and backward direction in order to remove the foreign objects causing the blockage. These measures are, however, often time-consuming and expensive and result in undesired downtime of the centrifugal pump. While there is the risk that the blockage is not resolved or is only partially resolved if a cleaning sequence is too short, the centrifugal pump can be unproductive for an unnecessarily long time if a cleaning sequence is too long.

In this respect, there is a need for an improved method for removing a blockage in centrifugal pumps which more precisely identifies whether the blockage has been removed and at the same time minimizes energy consumption of the centrifugal pump. A solution which allows the cleaning sequence to be carried out in a needs-based manner and allows for objective evaluation of the success of the cleaning sequence would be particularly advantageous.

### DESCRIPTION OF THE INVENTION

Proceeding from this situation, the problem addressed by the present invention is to provide a method and a corresponding centrifugal pump of which the cleaning sequence first of all ensures that a blockage is removed in order to improve an operating time of the centrifugal pump.

The problem addressed by the invention is solved by the features of the independent claims. Advantageous configurations are found in the dependent claims.

Accordingly, the problem is solved by a method for removing a blockage of a centrifugal pump comprising an electric motor for driving the centrifugal pump, comprising the steps of:
carrying out a cleaning sequence to remove the blockage;
after and/or while carrying out the cleaning sequence, checking whether a starting energy which is consumed by the electric motor during a start-up phase and is determined by integration of an electrical power consumption of the electric motor exceeds a starting energy threshold value; and
if so, carrying out the cleaning sequence again and/or in a continuing manner.

In other words, the method for removing the blockage of a centrifugal pump initially comprises the cleaning sequence in order to remedy the blockage. In principle, the cleaning sequence can have any configuration and for example consists of a defined series of forward and backward movements of an impeller of the centrifugal pump driven by the electric motor. After and/or during the cleaning sequence, a check is made as to whether the starting energy which is consumed by the electric motor during the start-up phase and is determined by integration of the electrical power consumption exceeds the starting energy threshold value. If this is the case, the cleaning sequence is carried out again or an already running cleaning sequence continues to be carried out.

An essential aspect of the proposed solution is that, in order to check whether the cleaning sequence has succeeded, i.e., for example, it has been possible to remove a foreign object blocking the centrifugal pump from the centrifugal pump, the starting energy consumed by the electric motor of the centrifugal pump during the start-up phase is determined by integration of the electrical power consumption of the electric motor, i.e. a motor input power of the electric motor, and is evaluated with regard to the threshold value.

The use of the motor input power to indirectly evaluate a load moment during the cleaning sequence is advantageous because the motor input power can be ascertained in a simple manner using current and voltage sensors that are routinely provided in the centrifugal pump anyway or are even already present owing to another use during closed-loop or open-loop control of the centrifugal pump. The motor input power is proportional to the product of torque and speed:

$${P}_{Motor , shaft} = {M}_{Motor , shaft} * ω$$

In this equation, P_{Motor, shaft} is the mechanical power at a motor shaft of the centrifugal pump, M_{Motor, shaft} is a shaft moment, and ω is the rotational frequency or the speed multiplied by 2π. The motor input power P_{Motor,in} is greater than motor shaft power P_{Motor, shaft}, since losses P_{Loss} occur in the electric motor and the frequency converter of the centrifugal pump, in particular iron and copper losses. In this respect, the following is applicable:

$${P}_{Motor , i n} = {P}_{Motor , shaft} + {P}_{Loss}$$

A core aspect is thus that of, after and/or while carrying out the cleaning sequence, using an energy-related variable W_{Load}, corresponding to the load moment M_{Load}, from the integration of the motor input power during the start-up phase for load moment evaluation. This energy-related variable W_{Load} does not need to be determined, however. Since the energy-related variable W_{Load} is part of the starting energy, it is sufficient to determine it. In this way, it can be simply and reliably identified whether the cleaning sequence was successful or whether it needs to be carried out again or in a continuing manner.

In other words, the starting energy includes an increase in kinetic energy from stoppage up to an evaluation speed and losses, such as friction, electrical losses, etc. Since, in particular, the latter values are often not known and can differ depending on direction of rotation, reference values are preferably determined by tests in a clean condition of the centrifugal pump. If, in a restart of the centrifugal pump, in particular during the cleaning sequence, the starting energy exceeds the reference value for a relevant direction, it can be concluded that a foreign object is in the pump chamber, i.e. in particular that there is a partial blockage or a blockage. If, after carrying out the cleaning sequence, for example forward and backward movements of the impeller, for example after stopping the electric motor or the impeller during a change in direction of rotation, the starting energy is again below the reference value, in particular in both directions of rotation of the impeller and/or the electric motor, the cleaning sequence can be considered to have been successful and can be terminated. Otherwise, a further cleaning sequence can be started.

By means of the proposed method, it is possible to implement a rinsing cycle for removing the blockage with a precisely required number of cleaning sequences without the rinsing cycle being terminated too soon and, on the other hand, without it being carried out for an unnecessarily long time, either. By means of the above-described steps, the blockage can be efficiently identified and remedied. Checking the starting energy during or after the cleaning sequence makes it possible to reliably determine a blockage level, meaning that the method adaptively reacts to various operation conditions.

In general, a continuous-flow machine which uses a rotational movement and dynamic forces for predominantly conveying liquids as the fluid is referred to as a centrifugal pump. In the centrifugal pump, in addition to tangential acceleration of the liquid, a centrifugal force occurring in radial flow is used for conveying, hence why pumps of this kind are referred to as centrifugal pumps. The centrifugal pump can preferably be used for a hydraulic system of a building or other applications, in particular as a dirty-water pump or wastewater pump.

In routine operation of the centrifugal pump, a housing of a motor of the centrifugal pump can be arranged above a pump housing, in which the impeller driven by the motor via a shaft and intended for conveying the liquid and the centrifugal chamber are provided. The housing of the motor can be rigidly connected to the pump housing and/or formed in one piece therewith. Likewise, the centrifugal pump and the motor can each comprise their own shaft, the shafts being interconnected by a coupling. The shaft preferably projects out of the housing of the motor into the pump housing on a drive side and/or is rigidly connected to the shaft on the drive side of the impeller. Accordingly, the suction opening for the fluid to be conveyed is preferably arranged on the bottom of the pump housing. The housing of the motor and/or the pump housing is preferably made of metal, in particular of cast iron or stainless steel, ceramic, and/or plastics material.

The fluid or liquid preferably includes water or another liquid medium, such as wastewater. The fluid or liquid can contain solid matter, such as dirt, impurities, or soiling of any kind, in particular feces, sediments, mud, sand, or also small pieces of wood, undergrowth, textiles, cloths, or the like, which can cause the blockage in the pump housing. In this respect, the term “blockage” also covers a partial blockage in which, for example, the impeller is still rotating, but is being prevented from operating normally by the solid matter.

The term “after and/or while carrying out the cleaning sequence” means that, for example, the check is made when the cleaning sequence is a quarter, halfway, or three-quarters of the way to being complete, with smaller units also being conceivable. The check is preferably made continuously during the cleaning sequence. The starting energy threshold value is preferably in a range between 10 and 10,000 Ws, preferably in the range of 100 to 10,000 Ws, particularly preferably in the range of 500 to 5,000 Ws. The starting energy threshold value is preferably dependent on the centrifugal pump, and is lower for smaller centrifugal pumps and higher for larger centrifugal pumps. The starting energy threshold value preferably constitutes a reference value obtained in a reference state of the centrifugal pump, in particular during operation of the electric motor in the forward and backward direction. The reference value can advantageously be tracked over a service life of the centrifugal pump, for example by means of a mean of a start-up evaluated as not being blocked over the last 10 start-ups, in order to avoid unnecessary cleaning cycles solely due to aging.

The invention contributes to meeting SDG 11 (Sustainable cities and communities) of the UN by improving the efficiency and reliability of wastewater systems. By means of the above-described method for the automated removal of blockages in centrifugal pumps, its operating time is maximized and its energy consumption is minimized. This encourages sustainable and efficient water and wastewater infrastructure, reduces maintenance costs, and reduces the environmental impact due to unnecessary downtime and manual interventions.

According to a preferred configuration, the method comprises the step of the centrifugal pump being driven in routine operation otherwise or if the starting energy does not exceed the starting energy threshold value. In this case, it is assumed that the blockage has been able to be resolved, such that the centrifugal pump can transition into routine operation, i.e. the centrifugal pump can be driven by the electric motor, as is provided for routine operation, known as normal operation. This facilitates efficient operation, since unnecessary cleaning sequences are avoided.

In another preferred configuration, it is provided that the cleaning sequence includes in particular repeated operation of the electric motor in the forward and backward direction, including temporarily stopping the electric motor. The start-up phase preferably begins after stopping the electric motor, when the electric motor begins to move in the forward and backward direction. Such a configuration improves efficacy of the cleaning sequence by achieving mechanical loosening of the blockage.

According to another preferred configuration, it is provided that the method comprises the step of identifying a blockage of the centrifugal pump and, if there is a blockage, carrying out the cleaning sequence. In this respect, the cleaning sequence is only carried out if the centrifugal pump is blocked or partially blocked, for example owing to sluggishness of the centrifugal pump, in particular as a result of aging, deposits, or similar signs of wear. Owing to this development, automatic blockage identification is made possible, meaning that unnecessary cleaning sequences are avoided.

In principle, there are various options known from the prior art for identifying the blockage. According to a preferred configuration, it is provided that identifying the blockage includes checking whether a calculated variation coefficient of an operating parameter of the centrifugal pump exceeds a permissible variation coefficient of the operating parameter. A check is preferably made as to whether a mean of a power signal, in particular a change in the power or a change in a power fluctuation, in the last number of seconds is less than a mean of the power signal after the next number of seconds by a percentage. This allows blockages to be precisely identified on the basis of the variability of the operating parameters.

According to a particularly preferred configuration, it is provided that the electric motor is controlled in a closed-loop manner by means of a closed-loop controller, wherein, in order to identify the blockage, a check is made as to whether activity of the closed-loop controller has fallen below a threshold value and whether a motor current and/or torque of the electric motor differs before and after the activity falls below the threshold value, wherein the activity of the closed-loop controller is determined by a product of the high-pass-filtered speed of the electric motor and the high-pass-filtered motor current and/or the high-pass-filtered torque of the electric motor, in particular to differentiate between command behavior and disturbance behavior. This increases the accuracy of blockage identification by the activity of the closed-loop controller being used as an in particular additional criterion.

In other words, it is proposed to use the activity of the closed-loop controller as a measure for detecting an imminent blockage. The activity of the closed-loop controller in particular describes a frequency and intensity of a change in a manipulated variable of the closed-loop controller, specifically the product, in particular a multiplication, of the high-pass-filtered speed of the electric motor and the high-pass-filtered motor current and/or the high-pass-filtered torque of the electric motor. At the ideal stationary operating point, the activity of the closed-loop controller is preferably always zero, i.e. the closed-loop controller does not have to change its manipulated variable and a controlled variable, in particular the speed, does not change either. In this respect, according to a preferred development, the threshold value is zero or approximately zero. This means that even very small changes in the activity of the closed-loop controller can be regarded as potential indicators of a blockage, and this results in particularly sensitive identification. If, however, a target value is changed or a load is changed, the closed-loop controller has to change its output in order to set the new target value or react to a load that has changed. In this case, a distinction can be drawn between command behavior, a change in the target value, and disturbance behavior, a change in the load. The closed-loop controller is in particular configured to be computer-based, for example as part of an open-loop and/or closed-loop control device.

Alternatively or additionally, it may be provided that the method comprises the step of: checking whether the activity of the closed-loop controller differs by more than 2.5, 5, 7.5, 10, or 20% both before and after it falls below the threshold value. This makes it possible to flexibly adapt the blockage identification to different operating conditions and to identify the blockage more precisely, since significant differentiation from normal operating deviations is ensured. According to another preferred configuration, the method comprises the step of: checking whether the activity of the closed-loop controller differs at least 0.1, 0.5, 1, 2, 5, or 10 seconds both before and after it falls below the threshold value. In other words, a check is preferably made as to whether a mean power is different before and after an event or whether a power variance, in particular a fluctuation, is increased, in order to identify the blockage. The threshold value is, for example, 5, 10, 15, or 20% below the regular activity of the closed-loop controller, i.e. in routine operation. By means of these measures, it can be ensured that blockages are identified in good time. Furthermore, it can be ensured that temporary, non-critical fluctuations are not incorrectly identified as a blockage.

According to a particularly preferred configuration, it is provided that the activity of the closed-loop controller is in particular further determined by a gradient of a progression over time, in particular a derivation, of the motor current and/or the torque. The activity of the closed-loop controller is thus determined from the derivation of the manipulated variable. This makes it possible to more accurately identify changes in the operating behavior of the motor, since, due to a dynamic approach, a change in the operating behavior makes it possible to identify deviations more accurately.

The multiplication of the high-pass-filtered speed of the electric motor and the high-pass-filtered torque and/or motor current allows changes in the activity of the closed-loop controller to be detected in a more robust manner. By means of the multiplication, a signal is obtained that represents the activity of the closed-loop controller and at the same time can differentiate between command behavior and disturbance behavior. This allows for reliable signal analysis by disturbing direct components being filtered out.

If there is a jump in target value, it is in particular the case that the torque is initially increased and then the speed is also increased. Both changes are positive and multiplication of the high-pass-filtered signals thus likewise results in a positive value. If the speed is reduced, the torque in particular initially has to be reduced and the speed also drops. If both changes are negative, a product or the multiplication of the signals is positive. In the event of an increase in the load moment, the speed will preferably initially drop, such that the closed-loop controller reacts by increasing the torque. In this case, the changes in the speed and torque are opposed and the product is negative.

It behaves in precisely the opposite way when the load moment drops. The speed increases and the closed-loop controller reacts in particular by decreasing the load moment. Again, the product of the changes, i.e. the high-pass-filtered signals, is negative. In summary, the activity of the closed-loop controller is in particular positive if the target value changes and negative if a disturbance or blockage occurs.

For the problem set out above, in particular only the disturbance behavior is of interest, since the ingress of an object or foreign object into the pump housing is understood to be a disturbance of the operation of the centrifugal pump by a homogeneous medium or blockage. In addition to the definition of an undisturbed, i.e. routine, state and separation of the command response and disturbance response, the calculation of the activity of the closed-loop controller by high-pass filtering and multiplication of manipulated variables and controlled variables has the advantage that behavior of the activity of the closed-loop controller over time can be effectively set by selecting a filter time constant and/or a cut-off frequency of the high-pass filter. If the filter time constant is then selected to be similar to the disturbance suppression of the closed-loop controller, individual events can be resolved and in particular the blockage can be identified.

Alternatively or additionally, it can be provided that the centrifugal pump, in the start-up phase, initially runs up to speed from a speed of zero in a controlled manner and then transitions into speed-regulated operation. The start-up phase can begin at the point in time T₁ at the frequency of zero and can end at the point in time T₂ when a predetermined target frequency is reached. A difference T₂−T₁ forms an acceleration time T. The start-up phase is in particular purely frequency-controlled operation of the centrifugal pump, known as open loop operation, i.e. the speed is not controlled in a closed control loop, known as closed-loop operation.

Before the start-up phase, a rotor of the electric motor is preferably magnetically aligned based on a stator field of the electric motor before the start-up phase such that a rotor field of the electric motor and the stator field point in the same direction. This has the advantage that the rotor is brought into a defined, stable starting position such that the rotor does not start up in the wrong direction. The rotor can be aligned in a manner known per se by successively applying two stator field vectors. Overall, this configuration ensures a controlled and optimized start-up phase.

According to another preferred configuration, it is provided that, in the start-up phase, the centrifugal pump is accelerated by a defined acceleration function which is identical to an acceleration function used previously, in particular at the factory or when operated by a customer, to obtain comparative values for the starting energy. This makes it possible for the starting energy to be compared in an improved manner. In a configuration variant, it can also be provided that the acceleration always, i.e. in each starting process, takes place using the same acceleration function, so that the starting energies of all the starting processes of the centrifugal pump can be compared with one another.

Alternatively or additionally, it can be provided that the acceleration function is defined by a predetermined acceleration time, a predetermined, in particular constant, acceleration progression, and a predetermined current amplitude, with a determined target speed being reached at the end of the acceleration time. The acceleration function in the start-up phase can be defined by the predetermined acceleration time T=T₂−T₁, a predetermined speed progression, and a predetermined current amplitude I_{OL}. A transition into operation of which the speed is controlled in a closed-loop manner preferably takes place when the specified target speed has been reached at the end of the acceleration time T. In this respect, after the start-up phase, the speed can be controlled in a closed control loop, for example by means of field-oriented closed-loop control. This allows the start-up phase to be precisely controlled.

The motor input power can be determined from a measurement of current and voltage, preferably on the output side at a frequency converter of the centrifugal pump. By integration of the motor input power during an acceleration process in the start-up phase, the starting energy W can be determined. This starting energy W includes kinetic energy Wₖᵢₙ introduced into the centrifugal pump, motor losses Wₗₒₛₛ, and an energy-related variable W_{load}, which is representative of a level of the load moment M_{load}. This is illustrated by the following equation:

$$W = {\int }_{T 1}^{T 2} Pdt = {W}_{kin} + {W}_{loss} + {W}_{load}$$

If the same acceleration function is always used, i.e. the acceleration always takes place with the same parameters, for example current amplitude, acceleration time, in particular ramp time, and acceleration progression, in particular ramp gradient, it can be assumed, in a good approximation and while disregarding temperature dependencies, that variables of the kinetic energy Wₖᵢₙ and the motor losses Wₗₒₛₛ contained in the power integral

$${\int }_{T 1}^{T 2} Pdt$$

are always the same. Temperature dependencies can, for example, be corrected by compensation or comparison of a power integral during parking. Since the temperature substantially influences the motor resistance and thus Ri², an Ri² integral can be determined during parking and the integral time and current amplitudes are subtracted from the starting energy in a corrected manner such that only iron losses and W_{load} remain.

A change in the variable W_{load} and thus a change in the load moment M_{load} can thus be concluded from a change in the starting energy W, i.e. a value of the power integral

$${\int }_{T 1}^{T 2} Pdt .$$

In other words, from the starting energy W, it can be identified whether something has changed in the hydraulic system in the operation of the centrifugal pump, i.e. either in the centrifugal pump itself or in the system in which the centrifugal pump conveys the fluid. This change is represented by the change in the W_{load} value. As already mentioned, numerical calculation of the value W_{load} is not required, since the change that has taken place in the centrifugal pump or the hydraulic system can be identified from the starting energy W, i.e. it can be identified whether the cleaning sequence has been successful and/or the blockage has been resolved or removed.

The order of method steps can be varied, unless an explicit order is required for technical reasons. The above-mentioned order of the method steps is preferably provided.

The problem addressed by the invention is further solved by a centrifugal pump comprising an electric motor for driving the centrifugal pump and a closed-loop and/or open-loop control device for the electric motor, wherein
the closed-loop and/or open-loop control device is configured to carry out a cleaning sequence to remove the blockage;
the closed-loop and/or open-loop control device is further configured to check, after and/or while carrying out the cleaning sequence, whether a starting energy which is consumed by the electric motor during a start-up phase and is determined by integration of an electrical power consumption of the electric motor exceeds a starting energy threshold value; and
if so, the closed-loop and/or open-loop control device is lastly configured to carry out the cleaning sequence again and/or in a continuing manner.

According to a preferred development, the centrifugal pump is configured as a wastewater pump. The closed-loop and/or open-loop control device is preferably configured to be computer-based, for example as a microcontroller.

Preferred developments of the centrifugal pump arise by analogy with the above-described method.

### BRIEF DESCRIPTION OF THE DRAWINGS

In the following, the invention will be explained in greater detail on the basis of preferred exemplary embodiments with reference to the accompanying drawings, in which:

FIG. 1 is a schematic view of a centrifugal pump for performing the proposed method according to a preferred exemplary embodiment of the invention,

FIG. 2 is a flow diagram for performing the proposed method according to the preferred exemplary embodiment of the invention,

FIG. 3 is a graph in which a starting energy is plotted at the top and a speed is plotted at the bottom during operation of the centrifugal pump in the forward and backward direction to determine reference values by tests in the clean state,

FIG. 4 is a graph in which the starting energy is plotted at the top and the speed is plotted at the bottom during a cleaning sequence,

FIG. 5 is a graph in which power over time is plotted at the top and a variation coefficient over time is plotted at the bottom and

FIG. 6 is an exemplary graph in which, from top to bottom, a motor current, the speed, and activity of the closed-loop controller over time are plotted.

### DETAILED DESCRIPTION OF THE EXEMPLARY EMBODIMENTS

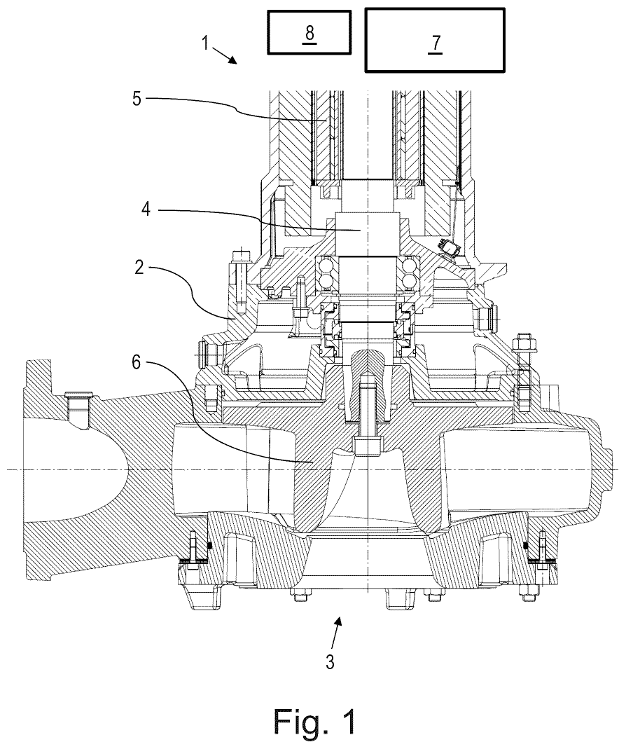

FIG. 1 is a schematic view of a centrifugal pump 1 for performing a method as described in the following, in particular for identifying and subsequently removing or resolving the blockage of the centrifugal pump 1 according to a preferred exemplary embodiment of the invention.

The centrifugal pump 1 configured as a wastewater pump comprises, in a conventional manner, a pump housing 2 comprising a suction opening 3 as an inlet, arranged at the bottom on the pump housing 2 in the figure. A rotor 4 extending vertically in the figure is provided in the pump housing 2. The rotor 4 is part of an electric motor 5 (only shown to an extent), which is arranged opposite the suction opening 3. Facing the suction opening 3, an impeller 6 is provided, which is driven by the rotor 4 of the electric motor 5. Furthermore, the centrifugal pump 1 comprises a microprocessor-based closed-loop and/or open-loop control device 7 or a closed-loop controller 7, which is merely indicated in FIG. 1.

Lastly, the centrifugal pump 1 comprises a sensor 8 for detecting a current consumed by the electric motor 5 of the centrifugal pump 1 and a voltage. The sensor 8 is accordingly configured as a current and/or voltage sensor. The in particular computer-implemented method described in the following for identifying and removing a blockage of the centrifugal pump 1 is carried out by a computer (not shown), in particular the closed-loop and/or open-loop control device 7.

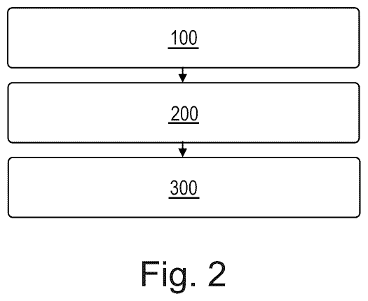

The method comprises the steps, shown schematically in FIG. 2, of:
checking whether activity of the closed-loop controller 7 has fallen below a threshold value and whether a motor current and/or torque of the electric motor 5 differs before and after the activity falls below the threshold value, in order to identify the blockage, wherein the activity of the closed-loop controller 7 is determined by a product of the high-pass-filtered speed of the electric motor 5 and the high-pass-filtered motor current and/or the high-pass-filtered torque of the electric motor 5, 100,
if so in particular, after and/or while carrying out a cleaning sequence to remove the blockage, checking whether a starting energy which is consumed by the electric motor 5 during a start-up phase and is determined by integration of an electrical power consumption of the electric motor 5 exceeds a starting energy threshold value, 200; and
if so, carrying out the cleaning sequence again and/or in a continuing manner 300.

In this respect, the method can be divided into two essential aspects, namely, in a first aspect, initially identifying whether there is a blockage, and then carrying out the cleaning sequence to remove the identified blockage. In a second aspect, the method includes, after and/or while carrying out the cleaning sequence, checking whether the blockage has been removed, and where necessary carrying out the cleaning sequence again and/or in a continuing manner. In the following, the second aspect is described first, followed by the first aspect.

The cleaning sequence that proceeds when there is a blockage of the centrifugal pump 1 includes repeated operation of the electric motor 5 in the forward and backward direction, including temporarily stopping the electric motor 5. During an acceleration process of the electric motor 5 in the start-up phase from the stopped electric motor 5 in the forward and backward direction, a motor shaft and the impeller 6 of the centrifugal pump 1 connected thereto is accelerated in accordance with a defined acceleration function.

In the start-up phase, the centrifugal pump 1 initially runs up to speed from a speed of zero in a controlled manner and then transitions into speed-regulated operation. In this start-up phase, the centrifugal pump 1 is accelerated by a defined acceleration function which is identical to an acceleration function used previously to obtain comparative values for the starting energy. The acceleration function is defined by a predetermined acceleration time, a predetermined, in particular constant, acceleration progression, and a predetermined current amplitude, with a determined target speed being reached at the end of the acceleration time. The starting energy includes an increase in kinetic energy from stoppage up to an evaluation speed and losses, such as friction, electrical losses, etc.

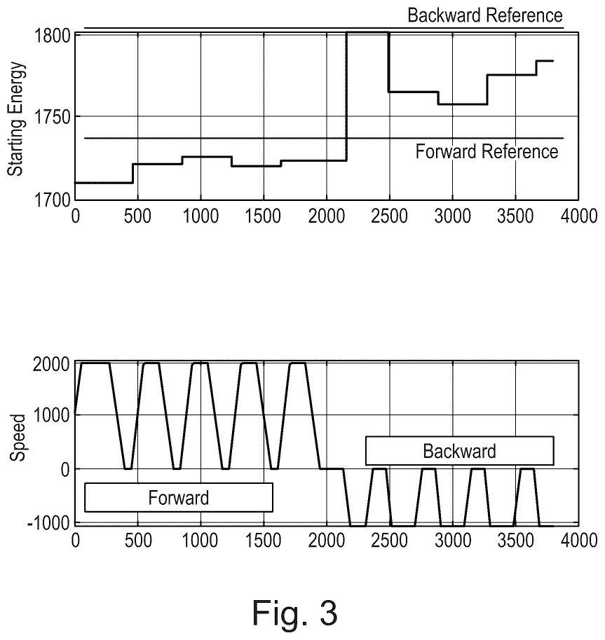

Since, in particular, the latter values are often not known and can differ depending on direction of rotation, reference values are preferably determined by tests in a clean condition of the centrifugal pump 1. In the graph in FIG. 3, by way of example, the starting energy is plotted at the top and the speed is plotted at the bottom during operation of the centrifugal pump 1 in the forward and backward direction to determine reference values by tests in the clean state.

If, in a restart of the centrifugal pump 1, in particular during the cleaning sequence, the starting energy exceeds the reference value for a relevant direction, it can be concluded that a foreign object is in the pump chamber, i.e. in particular that there is a partial blockage or a blockage.

Specifically, during this start-up phase having the defined acceleration function, by means of the sensor 8, the current consumed by the electric motor 5 and the consumed voltage are detected, from which a motor input power, the electrical power consumption of the electric motor 5 during the start-up phase, is detected. The current and voltage are preferably measured on the output side at a frequency converter of the centrifugal pump 1. By integration of the motor input power during the acceleration process in the start-up phase, the starting energy is determined.

This starting energy W includes kinetic energy Wₖᵢₙ introduced into the centrifugal pump, motor losses Wₗₒₛₛ, and an energy-related variable W_{load}, which is representative of a level of the load moment M_{load}, as illustrated by the following equation:

$$W = {\int }_{T 1}^{T 2} Pdt = {W}_{kin} + {W}_{loss} + {W}_{load}$$

The closed-loop and/or open-loop control device 7 then checks whether the thus determined starting energy W exceeds a starting energy threshold value, i.e. whether the centrifugal pump 1 is blocked. The check is carried out after and/or while carrying out the cleaning sequence, i.e., for example, periodically and/or each time the electric motor 5 is started up again.

If the check shows that the starting energy threshold value has been exceeded, i.e. that the centrifugal pump 1 is still blocked, the cleaning sequence is carried out again and/or in a continuing manner. Otherwise, if the starting energy no longer exceeds the starting energy threshold value, i.e. the blockage is removed, the electric motor 5 of the centrifugal pump 1 is driven in a routine manner or the centrifugal pump 1 is operated in normal operation again.

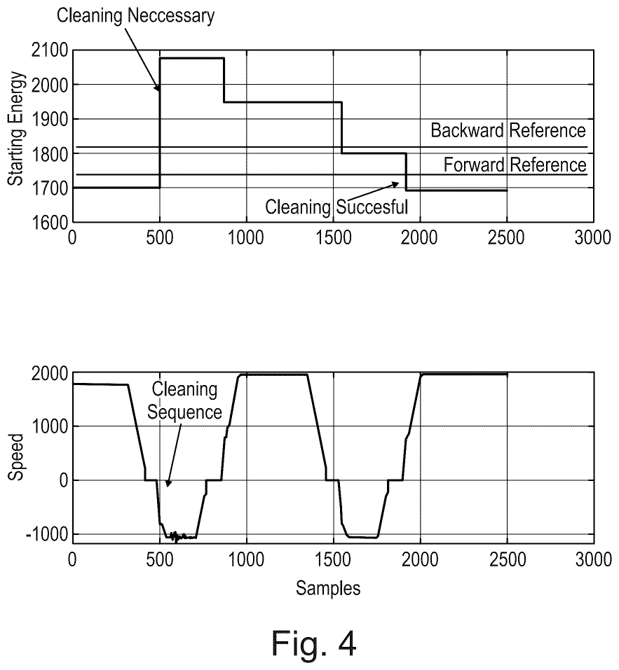

In the graph in FIG. 4, by way of example, the starting energy is plotted at the top and the speed is plotted at the bottom during a cleaning sequence. In the identification of the blockage described below, the cleaning sequence begins and ends once the starting energy of the electric motor 5 falls below the starting energy threshold value again.

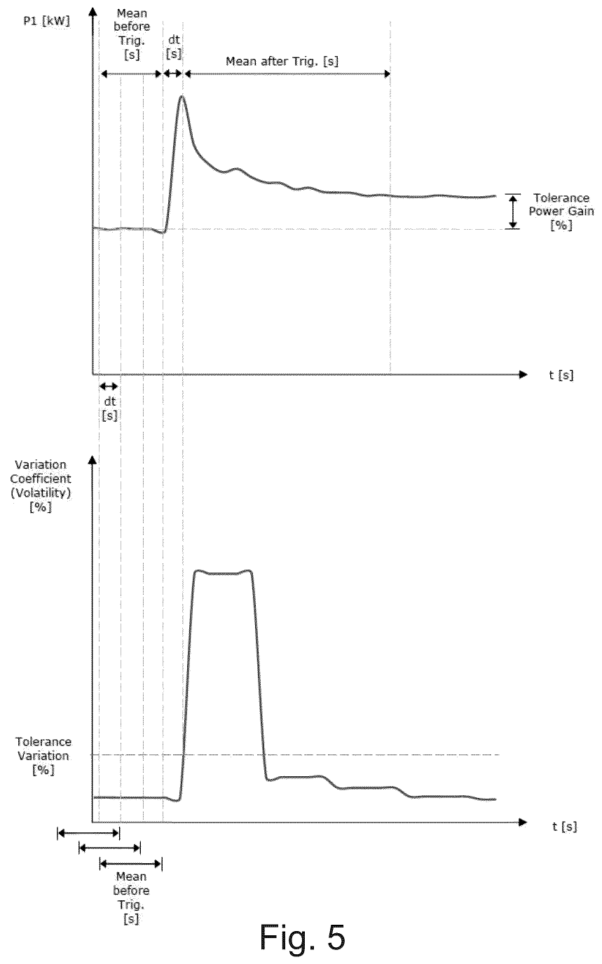

The identification of whether there is a blockage of the centrifugal pump 1 at all takes place before the cleaning sequence is carried out, for which purpose various methods are possible. In a first variant, identifying the blockage includes checking whether a calculated variation coefficient of an operating parameter of the centrifugal pump 1 exceeds a permissible variation coefficient of the operating parameter. By way of example, FIG. 5 is a graph in which the power over time is plotted at the top and the variation coefficient over time is plotted at the bottom.

In a second variant preferred by contrast, the electric motor 5 is controlled in a closed-loop manner by means of the closed-loop controller 7, which is part of the closed-loop and/or open-loop control device 7. Specifically, in this second variant, for identifying the blockage, the closed-loop and/or open-loop control device 7 checks whether the activity of the closed-loop controller 7 has fallen below the threshold value and whether the motor current and/or torque of the electric motor 5 differs before and after the activity falls below the threshold value, wherein the activity of the closed-loop controller 7 is determined by the product of the high-pass-filtered speed of the electric motor 5 and the high-pass-filtered motor current and/or the high-pass-filtered torque of the electric motor 5, in particular in order to differentiate between command behavior and disturbance behavior.

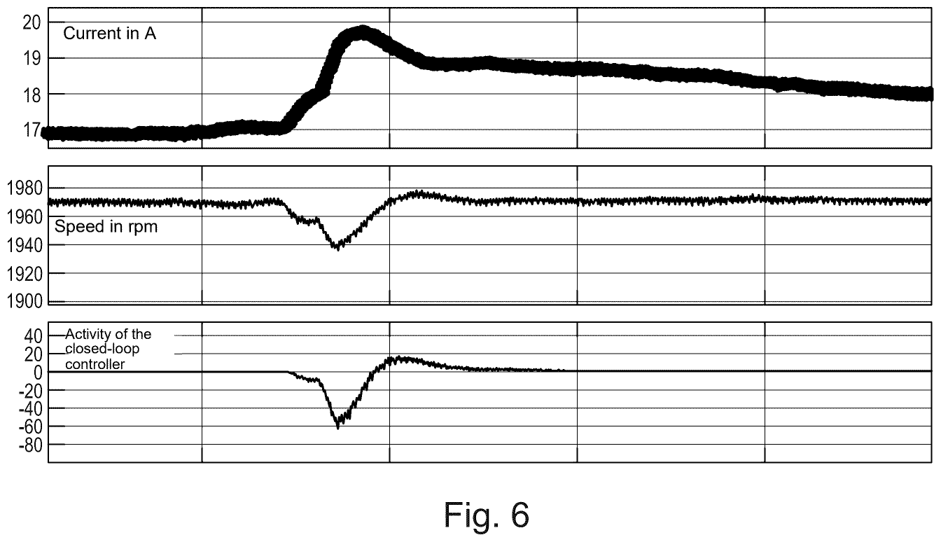

FIG. 6 is an exemplary graph in which, from top to bottom, the motor current, the speed, and the activity of the closed-loop controller over time are plotted. A disturbance event can be identified since the activity of the closed-loop controller drops over time. Since the activity of the closed-loop controller 7 falls below the threshold value, i.e. has a negative sign in the present case, and the activity of the closed-loop controller 7 is below a threshold value and differs both before and after the activity falls below the threshold value or before and after the disturbance event, it can be concluded that there is a disturbing object in the pump housing which negatively impacts the degree of efficiency of the pump. In this respect, the above-described cleaning sequence can be initiated.

The activity of the closed-loop controller 7 can further be determined by a gradient of a progression over time, in particular a derivation, of the motor current and/or the torque. Specifically, the activity of the closed-loop controller 7 is determined by the multiplication of the high-pass-filtered speed of the electric motor 5 and the high-pass-filtered torque and/or high-pass-filtered motor current. In this case, the activity of the closed-loop controller 7 has to differ by more than 2.5, 5, 7.5, 10, or 20% before and after it falls below the threshold value. Furthermore, the activity of the closed-loop controller 7 is observed at least 0.1, 0.5, 1, 2, 5, or 10 seconds before and after it falls below the threshold value.

5 The exemplary embodiments described are merely examples which can be modified and/or supplemented in various ways in the context of the claims. Any feature that has been described for a particular exemplary embodiment can be used on its own or in combination with other features in any other exemplary embodiment. Any feature that has been described for an exemplary embodiment in a particular category can also be used in a corresponding manner in an exemplary embodiment in another category.

### LIST OF REFERENCE SIGNS

Centrifugal pump 1
Pump housing 2
Suction opening 3
Rotor 4
Electric motor 5
Impeller 6
Open-loop and/or closed-loop control device, closed-loop controller 7
Sensor 8

Checking whether activity of the closed-loop controller 7 has fallen below a threshold value and whether a motor current and/or torque of the electric motor 5 differs before and after the activity falls below the threshold value, in order to identify the blockage, wherein the activity of the closed-loop controller 7 is determined by a product of the high-pass-filtered speed of the electric motor 5 and the high-pass-filtered motor current and/or the high-pass-filtered torque of the electric motor 5 100 after and/or while carrying out a cleaning sequence to remove the blockage, checking whether a starting energy which is consumed by the electric motor 5 during a start-up phase and is determined by integration of an electrical power consumption of the electric motor 5 exceeds a starting energy threshold value 200 if so, carrying out the cleaning sequence again and/or in a continuing manner 300

1. A method for removing a blockage of a centrifugal pump comprising an electric motor for driving the centrifugal pump, comprising the steps of:
at least one of after and while carrying out a cleaning sequence to remove the blockage, checking whether a starting energy which is consumed by the electric motor during a start-up phase and is determined by integration of an electrical power consumption of the electric motor exceeds a starting energy threshold value; and
if so, carrying out the cleaning sequence at least one of again and in a continuing manner.

2. The method according to claim 1, further comprising the step of:
otherwise, if the starting energy does not exceed the starting energy threshold value, driving the centrifugal pump.

3. The method according to claim 1, wherein the cleaning sequence includes an operation of the electric motor in the forward and backward direction, including temporarily stopping the electric motor.

4. The method according to claim 1, wherein the cleaning sequence includes repeated operation of the electric motor in the forward and backward direction, including temporarily stopping the electric motor.

5. The method according to claim 1, further comprising the step of:
identifying the blockage of the centrifugal pump; and
if there is a blockage, carrying out the cleaning sequence.

6. The method according to claim 5, wherein identifying the blockage includes checking whether a calculated variation coefficient of an operating parameter of the centrifugal pump exceeds a permissible variation coefficient of the operating parameter.

7. The method according to claim 4, wherein the electric motor is controlled in a closed-loop manner by means of a closed-loop controller, and comprises the step of:
checking whether an activity of the closed-loop controller has fallen below a threshold value and whether at least one of a motor current and a motor torque of the electric motor differs before and after the activity falls below the threshold value, in order to identify the blockage, wherein the activity of the closed-loop controller is determined by a product of the high-pass-filtered speed of the electric motor and at least one of the high-pass-filtered motor current and the high-pass-filtered torque of the electric motor.

8. The method according to claim 7, further comprising the step of:
checking whether the activity of the closed-loop controller differs by more than 2.5% both before and after it falls below the threshold value.

9. The method according to claim 7, further comprising the step of:
checking whether the activity of the closed-loop controller differs at least 0.1 seconds both before and after it falls below the threshold value.

10. The method according to claim 7, wherein the activity of the closed-loop controller is determined by a gradient of a progression over time of at least one of the motor current and the motor torque.

11. The method according to claim 7, wherein the activity of the closed-loop controller is further determined by a gradient of a progression over time or a derivation of at least one of the motor current and the torque.

12. The method according to claim 1, wherein the centrifugal pump, in the start-up phase, initially runs up to speed from a speed of zero in a controlled manner and then transitions into speed-regulated operation.

13. The method according to claim 1, wherein in the start-up phase, the centrifugal pump is accelerated by a defined acceleration function which is identical to an acceleration function used previously to obtain comparative values for the starting energy.

14. The method according to claim 13, wherein the acceleration function is defined by a predetermined acceleration time, a predetermined acceleration progression, and a predetermined current amplitude, with a determined target speed being reached at the end of the acceleration time.

15. The method according to claim 13, wherein the acceleration function is defined by a predetermined acceleration time, a predetermined, constant, acceleration progression, and a predetermined current amplitude, with a determined target speed being reached at the end of the acceleration time.

16. A centrifugal pump comprising an electric motor for driving the centrifugal pump and at least one of a closed-loop and an open-loop control device for the electric motor, wherein
the at least one of the closed-loop and the open-loop control device is configured to carry out a cleaning sequence to remove a blockage;
the at least one of the closed-loop and the open-loop control device is further configured to check, at least one of after and while carrying out the cleaning sequence, whether a starting energy, which is consumed by the electric motor during a start-up phase and is determined by integration of an electrical power consumption of the electric motor, exceeds a starting energy threshold value; and
if so, the at least one of the closed-loop and the open-loop control device is configured to carry out the cleaning sequence at least one of again and in a continuing manner.

17. The centrifugal pump according to claim 1, wherein the centrifugal pump is configured as a wastewater pump.
